(19) United States
(12) Patent Application Publication
(10) Pub. No.: US 2024/0356288 A1
(43) Pub. Date: Oct. 24, 2024

(54) SHIELD CONNECTOR

(71) Applicant: Yazaki Corporation, Tokyo (JP)

(72) Inventors: Kouki IWAKURA, Makinohara-shi (JP); Toshikazu Yoshioka, Makinohara-shi (JP); Takashi Sone, Makinohara-shi (JP)

(73) Assignee: Yazaki Corporation, Tokyo (JP)

(21) Appl. No.: 18/613,986

(22) Filed: Mar. 22, 2024

(30) Foreign Application Priority Data
Apr. 19, 2023 (JP) 2023-068557

(51) Int. Cl. H01R 13/6592

(52) U.S. Cl. CPC H01R 13/6592

(57) ABSTRACT

A shield connector includes a tubular braided conductor configured to be externally mounted on an electric wire; a shield shell configured to have a tubular portion covered with the braided conductor; an inner housing configured to be inserted into the shield shell; and an electric wire holder configured to be attached to an end portion of the inner housing in an insertion direction and support the electric wire, in which the inner housing is provided with a locking portion, the electric wire holder includes a locking receiving portion that locks the locking portion, and a plate-shaped base provided to extend in a direction intersecting an axis of the shield shell, and the base abuts against an end portion of the shield shell when the locking receiving portion locks the locking portion.

### BACKGROUND

### Technical Field

The present invention relates to a shield connector.

### Related Art

Various electronic devices are mounted on automobiles, and wire harnesses are routed in order to transmit power, control signals, and the like to the electronic devices. The wire harness includes a plurality of electric wires and a connector and is connected to the electronic device or another wire harness by fitting the connector to a connector of the electronic device or a connector of another wire harness.

As a connector used for such a wire harness, a shield connector to be attached to terminals of two shielded cables that handle high voltages such as an electric vehicle (EV) and a hybrid electric vehicle (HEV) is known (See, for example, JP 2022-25642 A).

A shield connector in the related art disclosed in JP 2022-25642 A includes a shield body externally mounted on a pair of electric wires, a tubular housing, and a rear holder that is engaged with a rear end portion of the housing and supports the pair of electric wires. The shield body includes a tubular braided conductor externally mounted on the pair of electric wires and a shield shell having a tubular shell body covered with the braided conductor. The housing has a flange portion at an intermediate portion in the axis direction, and the housing is fixed such that the flange portion of the housing is interposed between the shield shell and a casing.
Patent Literature 1: JP 2022-25642 A

### SUMMARY

However, in the shield connector in the related art, since the shell body covered with the braided conductor in the shield shell and the housing are not in a fixed state, it is required to take care when assembling the braided conductor to the shell body.

An object of the present invention is to provide a shield connector that improves assembly workability.

In order to solve the above problems and achieve the object, a shield connector according to the present invention includes a tubular braided conductor configured to be externally mounted on an electric wire; a shield shell configured to have a tubular portion covered with the braided conductor; an inner housing configured to be inserted into the shield shell; and an electric wire holder configured to be attached to an end portion of the inner housing in an insertion direction and support the electric wire, in which the inner housing is provided with a locking portion, the electric wire holder includes a locking receiving portion that locks the locking portion, and a plate-shaped base provided to extend in a direction intersecting an axis of the shield shell, and the base abuts against an end portion of the shield shell when the locking receiving portion locks the locking portion.

According to the present invention, it is possible to improve assembly workability.

### BRIEF DESCRIPTION OF DRAWINGS

FIG. 1 is a cross-sectional view illustrating a main part of a shield connector according to an embodiment of the present invention; and

FIG. 2 is a perspective view illustrating a rear holder (electric wire holder) that configures the shield connector.

### DETAILED DESCRIPTION

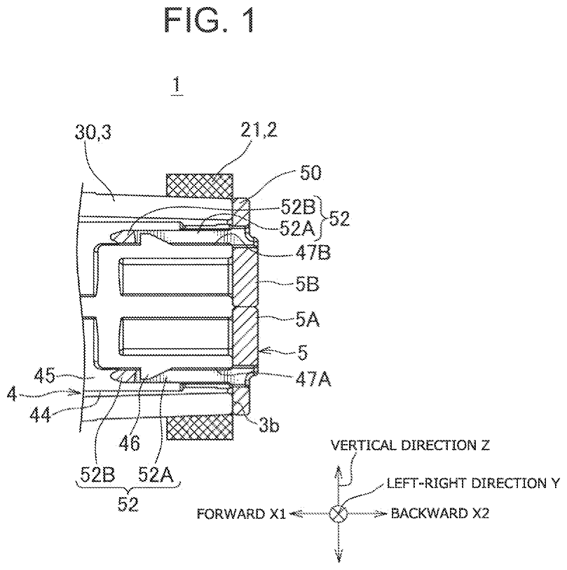

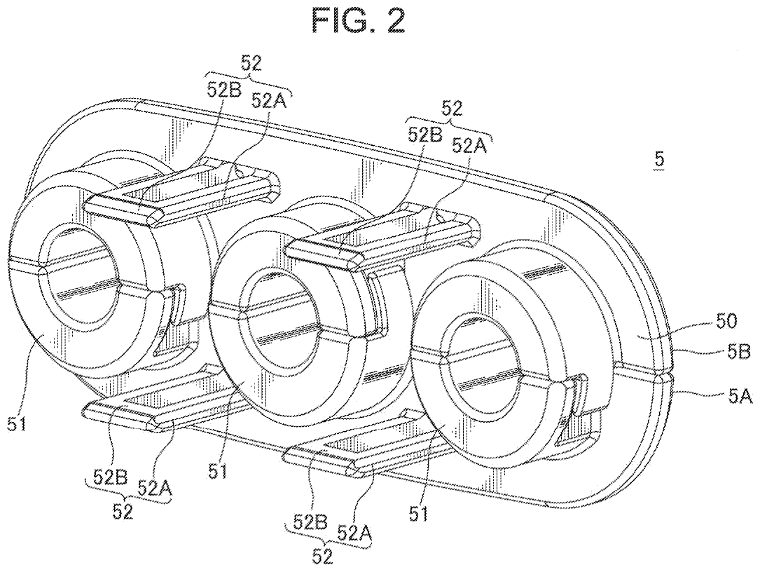

Hereinafter, an embodiment of the present invention is described with reference to FIGS. 1 to 2. A perspective view illustrating a shield connector according to an embodiment of the present invention is provided. A shield connector 1 configures a wire harness routed in an automobile or the like and configures a shield circuit that shields electrical noise leaking from an electric wire that transmits a control signal or the like to the outside or electrical noise flowing in from the outside. In addition, the shield connector 1 is fixed to a casing of an in-vehicle device (not illustrated) with a bolt in a state where a fixing piece (not illustrated) of a shield shell 3 (described below) overlaps the casing.

As illustrated in FIG. 1, the shield connector 1 of the present embodiment includes a tubular braided conductor 2 (illustrated in FIG. 1) externally mounted on three electric wires (not illustrated), a shield shell 3 having a tubular portion 30 covered with the braided conductor 2, a housing 4 (inner housing) accommodated in the shield shell 3, and a rear holder 5 (electric wire holder) attached to a rear end portion (end portion) of the housing 4 to support the three electric wires.

Hereinafter, arrows X, Y, and Z are directions orthogonal to each other. A direction in which the tubular portion 30 of the shield shell 3 extends may be indicated by an “arrow X”, a left-right direction in which terminal accommodating portions (not illustrated) formed in the housing 4 are aligned may be indicated by an “arrow Y”, and a vertical direction orthogonal to the arrow X and the arrow Y may be indicated by an “arrow Z”. In addition, in the arrow X, one end side of the shield shell 3 (the side on which the fixing piece is provided) may be referred to as “forward X1”, and the opposite side may be referred to as “backward X2”.

The braided conductor 2 is formed, for example, by braiding a braided wire (element wire) made of a conductive metal material or the like into a mesh shape. As illustrated in FIG. 1, the braided conductor 2 includes a tubular braided conductor main body (not illustrated) and a fixing portion 21 that is provided at an end (front end portion) of the braided conductor main body in the axis direction and is covered with and fixed to the tubular portion 30 (described below) of the shield shell 3. The fixing portion 21 is configured to be caulked and fixed to the tubular portion 30 of the shield shell 3.

The shield shell 3 is configured with conductive metal. As illustrated in FIG. 1, the shield shell 3 includes the elliptical tubular portion 30 extending in the front-back direction X and a fixing piece rising from a front end of the tubular portion 30 and overlapping the casing of the in-vehicle device. The fixing piece is configured to be fixed to the casing of the in-vehicle device with a bolt in a state of being overlapped with the casing.

The housing 4 is configured with an insulating synthetic resin. As illustrated in FIG. 1, the housing 4 includes a housing base (not illustrated), three terminal accommodating portions (not illustrated) that is provided to protrude forward X1 from the housing base and accommodates respective terminals (not illustrated), a hood portion (not illustrated) that is provided to protrude forward X1 from the housing base and surrounds the three terminal accommodating portions, and a tubular portion to be inserted 44 that is continuous backward X2 of the three terminal accommodating portions and inserted into the shield shell 3. A component installation portion (not illustrated) in which a seal member (component, not illustrated) is installed is provided at a rear end of the hood portion.

Each of the three terminal accommodating portions is formed in a rectangular tubular shape and is formed so that the axis thereof extends in the front-back direction X. A terminal is accommodated in each of the terminal accommodating portions, and a mating terminal of the mating connector is configured to be in electrical contact with the terminal of each terminal accommodating portion in case of being fitted to the mating connector (not illustrated).

As illustrated in FIG. 1, the portion to be inserted 44 includes three electric wire accommodating portions 45 continuous backward X2 from each terminal accommodating portion and four (a plurality of) locking protrusions 46 (locking portions) provided between the adjacent electric wire accommodating portions 45 and locked to a lock arm 52 of a rear holder 5 described below. The four locking protrusions 46 face each other in the vertical direction Z, and two sets (four in total) are aligned in the left-right direction Y. Each locking protrusion 46 is provided so as to protrude upward and downward from a pair of flat surfaces 47A and 47B facing each other in the vertical direction Z. These locking protrusions 46 are provided between the adjacent electric wire accommodating portions 45 and are configured to be positioned inside the shield shell 3 (positioned not in contact with the shield shell 3) in a state where the housing 4 is inserted inside the shield shell 3.

As illustrated in FIG. 2, the rear holder 5 includes a plate-shaped rear base 50 formed in a track shape in plan view, three electric wire insertion portions 51 that extend in a tubular shape forward X1 from the rear base 50 and support the respective electric wires, the four (two sets) lock arms 52 that lock the locking protrusions 46 of the housing 4, and engagement arms (not illustrated) that are provided in the respective electric wire insertion portions 51 and engage with the housing 4. The three electric wire insertion portions 51 are aligned in the left-right direction Y.

As illustrated in FIG. 1, the rear holder 5 includes two members 5A and 5B formed so as to divide each electric wire insertion portion 51 into two in the vertical direction. In such a rear holder 5, the lower member 5A and the upper member 5B come close to each other in the vertical direction Z and come into contact with each other, so that the electric wire insertion portion 51 is configured to interposes and support each electric wire to configure the rear holder 5.

As illustrated in FIG. 2, the lock arm 52 includes an arm 52A that is formed to extend forward X1 from the rear base 50 and a lock projection 52B that is provided at a free end of the arm 52A and that can lock the locking protrusion 46 of the housing 4. The lock arms 52 face each other in the vertical direction Z, and two sets (four in total) are aligned in the left-right direction Y. Also, each lock arm 52 is provided in each of the lower member 5A and the upper member 5B between the electric wire insertion portions 51 adjacent to each other.

When such a rear holder 5 is mounted to the housing 4, each terminal is accommodated in each terminal accommodating portion of the housing 4, the electric wire is inserted into the portion to be inserted 44. In a state where the electric wire is pulled out from the housing 4, and the shield shell 3 is externally fitted to the portion to be inserted 44 of the housing 4, predetermined positions of the three electric wires are interposed between the lower member 5A and the upper member 5B of the rear holder 5, and each electric wire is supported by each electric wire insertion portion 51.

Thereafter, the rear holder 5 is moved forward X1 so that the rear holder 5 approaches the housing 4. As the movement further proceeds, the lock arm 52 provided in the rear holder 5 are respectively brought into contact with the locking protrusions 46 of the housing 4, and the lock arms 52 respectively ride on and ride over the locking protrusions 46 to lock the locking protrusions 46. At this time, the rear base 50 of the rear holder 5 abuts against a rear end portion 3b of the shield shell 3. At substantially the same time, the respect engagement arms provided in the rear holder 5 lock the housing 4.

In this state, the rear holder 5 is supported by the housing 4 so as to be restricted in movement in the front-back direction X of the housing 4, and the rear base 50 of the rear holder 5 abuts against the rear end portion 3b of the shield shell 3, thereby restricting movement of the shield shell 3 backward X2. That is, the shield shell 3 is prevented from coming off by the rear holder 5.

In this manner, the rear holder 5 is mounted to the housing 4. Thereafter, the fixing portion 21 of the braided conductor 2 covers and is fixed to the tubular portion 30 of the shield shell 3, whereby the shield connector 1 is assembled.

According to the embodiment described above, the housing 4 (inner housing) is provided with the locking protrusion 46 (locking portion), the rear holder 5 (electric wire holder) includes the lock arm 52 (locking receiving portion) that locks the locking protrusion 46 and the plate-shaped rear base 50 (base) provided to extend in the direction (ZY direction) intersecting the axis of the shield shell 3, and the rear base 50 is configured to abut against the rear end portion 3b (end portion) of the shield shell 3 when the lock arm 52 locks the locking protrusion 46. According to this, the rear base 50 abuts against the rear end portion 3b (end portion) of the shield shell 3 when the lock arm 52 locks the locking protrusion 46, whereby the tubular portion 30 of the shield shell 3 and the housing 4 are fixed to each other via the rear holder 5. As a result, when the braided conductor 2 is assembled to the tubular portion 30 of the shield shell 3, the tubular portion 30 of the shield shell 3, the housing 4, the rear holder 5, and the electric wires supported by the rear holder 5 are in a stable state, so that the assembly workability can be improved.

In addition, the locking portion is the convex locking protrusion 46 protruding toward the shield shell 3, the locking protrusion 46 is provided inside the shield shell 3 in a state where the housing 4 (inner housing) is inserted into the shield shell 3, and the locking receiving portion is formed to extend from the rear base 50 (base) in an opposite direction to the insertion direction and locks the locking protrusion 46 when the rear base 50 abuts against the rear end portion 3b (end portion) of the shield shell 3. According to this, the locking protrusion 46 of the housing 4 and the lock arm 52 of the rear holder 5 are locked inside the shield shell 3, and the shield shell 3 is not provided with the locking structure. Therefore, it is possible to eliminate the requirement for careful work when assembling the braided conductor 2 to the tubular portion 30 of the shield shell 3. That is, it is possible to further improve assembly workability.

Note that the present invention is not limited to the above embodiment and includes other configurations and the like that can achieve the object of the present invention, and the following modifications and the like are also included in the present invention.

In the above embodiment, the locking portion provided in the housing 4 (inner housing) is configured with the locking protrusion 46, and the locking receiving portion provided in the rear holder 5 (electric wire holder) is configured with the lock arm 52, but the present invention is not limited thereto. The rear base 50 (base) of the rear holder 5 (electric wire holder) may be configured to abut against the rear end portion 3b (end portion) of the shield shell 3 when the locking receiving portion locks the locking portion, the locking portion may be configured with the locking protrusion 46, and the locking receiving portion may not be configured with the lock arm 52. For example, the locking receiving portions may be provided so as to face each other in the left-right direction Y, and any locking means may be adopted.

In addition, the best configuration, method, and the like for carrying out the present invention are disclosed in the above description, but the present invention is not limited thereto. That is, although a specific embodiment is mainly particularly illustrated and described in the present invention, a person skilled in the art can make various modifications to the above-described embodiment in shapes, materials, quantities, and other detailed configurations without departing from the scope of the technical concept and the object of the present invention. Therefore, the description in which the shapes, the materials, and the like disclosed above are limited is illustratively described for better understanding of the present invention and does not limit the present invention. Therefore, the description in the name of the member in which a part or all of the limitations such as the shapes and the materials are removed is included in the present invention.

### REFERENCE SIGNS LIST

1 shield connector
2 braided conductor
3 shield shell
3b rear end portion (end portion) of shield shell
30 tubular portion
4 housing (inner housing)
46 locking protrusion (locking portion)
5 rear holder (electric wire holder)
50 rear base (base)
52 lock arm (locking receiving portion)

What is claimed is:

1. A shield connector comprising:
a tubular braided conductor configured to be externally mounted on an electric wire;
a shield shell configured to have a tubular portion covered with the braided conductor;
an inner housing configured to be inserted into the shield shell; and
an electric wire holder configured to be attached to an end portion of the inner housing in an insertion direction and support the electric wire, wherein
the inner housing is provided with a locking portion,
the electric wire holder includes a locking receiving portion that locks the locking portion, and a plate-shaped base provided to extend in a direction intersecting an axis of the shield shell, and
the base abuts against an end portion of the shield shell when the locking receiving portion locks the locking portion.

2. The shield connector according to claim 1, wherein
the locking portion is a convex locking protrusion protruding toward the shield shell,
the locking protrusion is provided inside the shield shell in a state where the inner housing is inserted into the shield shell, and
the locking receiving portion is formed to extend from the base in a direction opposite to the insertion direction and locks the locking protrusion when the base abuts against the end portion of the shield shell.
